(19) United States
(12) Patent Application Publication
(10) Pub. No.: US 2012/0064345 A1
(43) Pub. Date: Mar. 15, 2012

(54) PROCESS FOR THE PREPARATION OF AN AEROGEL IN PELLETS

(75) Inventor: Lucia Gini, Novara (IT)

(73) Assignee: EVONIK DEGUSSA GmbH, Essen (DE)

(21) Appl. No.: 13/318,733

(22) PCT Filed: May 17, 2010
(86) PCT No.: PCT/EP2010/056713

§ 371 Date: Nov. 3, 2011

(30) Foreign Application Priority Data
May 29, 2009 (IT) MI2009A000950

(51) Int. Cl. B32B 5/16; C01B 33/14

(52) U.S. Cl. 428/402; 423/338

(57) ABSTRACT

The present invention relates to a process for the preparation of an aerogel in the form of spherules or beads and the use thereof for thermal or sound insulation.

The present invention relates to an aerogel in the form of particles, the method for the preparation thereof, and the use thereof.

Aerogels are materials with well-known insulating properties, which are sometimes also used as catalysts or as intermediates in the preparation of vitreous or ceramic-vitreous materials, or again, they can be used in the production of integrated circuits. Aerogels are materials which display excellent mechanical strength properties accompanied by considerable porosity and entirely specific optical characteristics.

The preparation of aerogels is effected by the so-called “sol-gel” process, in which the starting material is a solution containing a solvent such as water, an alcohol or a water-alcohol mixture and a siliceous precursor Si(—OR)ₙ, which is hydrolysed at low pH, of the order of pH 1 or 2, according to the following scheme:

Si(—OR)ₙ+nH₂O→Si(OH)ₙ+nROH

This first stage is followed by the condensation stage from which a polymeric gel (OH)ₙ₋₁ Si—O—Si (OH)ₙ₋₁ is in fact obtained;

Si(OH)ₙ+Si(OH)ₙ→(OH)ₙ₋₁Si—O—Si(OH)ₙ₋₁+H₂O

In the final stage of the process, the solvent is removed, thus generating an “aerogel”, in other words a gel in which the liquid portion is replaced by a gas. In particular, in order not to destroy the delicate three-dimensional structure of the gel, the solvent can be removed by supercritical or hypercritical extraction, which operates by exploiting suitable conditions of temperature and pressure, at which the solvent passes from the liquid phase to the super-critical fluid phase. Examples of procedures for the supercritical extraction of the solvent are for example those described in U.S. Pat. No. 4,432,956 and U.S. Pat. No. 5,395,805.

If however the extraction stage would require unfavourable operating conditions, which could damage or alter the structure of the aerogel, it is possible to replace the solvent used with one having a lower critical temperature, so that the extraction can be carried out at more favourable pressure and/or temperatures and without the need to use expensive equipment such as autoclaves.

The process thus described makes it possible to obtain an aerogel in monolithic form, in other words free from fractures or breaks, even microscopic ones, in particular by pouring the sol obtained into a mould of the desired dimensions.

The first subject of the present invention is thus a process for the preparation of an aerogel in the form of particles or beads also referred to as spherules or pellets, which has advantageous mechanical properties, a high surface area and a high but controlled porosity, according to claim 1 and the dependent claims 2-13.

A second subject of the invention relates to the material obtained from the process described herein, such as from claim 14.

Other purposes and subjects of the present invention will become clear from the description provided below herein.

In the present invention, the term sol or sol-gel is understood to mean a colloidal suspension capable of solidifying forming a gel.

The shape in which this sol or sol-gel is obtained is represented by beads or spherules or pellets or particles having a spherical shape and diameter variable between ca. 100 μm and 10-15 mm.

In particular, the process for the preparation of an aerogel according to the present invention comprises the stages of:
a) forming a colloidal solution (sol) of silicon dioxide by hydrolysis of a tetraalkoxysilane;
b) adding the sol obtained from the previous stage to a dispersant liquid in which it is immiscible obtaining a two-phase composition;
c) dispersing said two-phase composition obtaining particles or beads;
d) allowing the gelling process to take place within the dispersed particles obtained from stage c);
e) filtering and washing the particles or beads obtained from stage d); and
f) extracting the solvent, wherein the particles obtained in stage c) have a diameter lying between ca. 0.1 and 15 mm.

In particular, in stage a) the sol is prepared by hydrolysis of a tetraalkoxysilane in an acidic medium by addition of a mineral acid. In this way, a clear single-phase colloidal solution (sol) is obtained, in proof that the hydrolysis has occurred.

In stage b) of the process of the present invention, the sol or sol-gel thus obtained is added, for example dropwise using a dropping funnel, to a dispersant liquid in which it is known to be immiscible. This causes the formation of particles or beads of colloidal solution.

After the addition of the sol to the dispersant liquid in which it is immiscible, there follows the dispersion stage c), which is effected by stirring, thus obtaining particles or beads of diameter lying between ca. 0.1 to 15 mm.

Once the dispersion of the solution of sol into droplets of the desired diameter has been achieved, in stage d) the two-phase suspension is kept constantly stirred for the time necessary to obtain the gelling.

In stage e) of the process of the present invention, the particles or beads obtained are filtered and washed in order to remove the organic solvent, which can then be recovered and recycled. Moreover, said washing can influence the hydrophilic or hydrophobic properties of the particles or beads obtained.

In the final stage of the process (stage f), the residual solvent, used in the course of the process or deriving from the exchange of the process, is finally extracted by hypercritical extraction in an autoclave, thus enabling the formation of a material with the specifications described below.

According to a preferred aspect of the invention, the mineral acid used for the hydrolysis of the tetraalkoxysilane in stage a) is preferably selected from phosphoric acid, sulphuric acid or hydrochloric acid or nitric acid, at a concentration variable between 0.01 and 4M.

In the present invention, particular care must be used in the implementation of stages a) and d).

According to a first aspect of the invention, the hydrolysis of the tetraalkoxysilane can be induced by adding it to the acidic aqueous solution at a pH lower than 2 (stage a)) and then dispersing the sol leaving its pH unchanged. In this case, depending on the pH value used, it is necessary to wait for a time that can be estimated at between >100 hrs and 0.5 hr before the gelling stage d) takes place.

In a second aspect of the invention, the hydrolysis of the tetraalkoxysilane can be induced by adding it to the acidic aqueous solution at pH 2 and, once the hydrolysis is completed, raising the pH by addition of a base, for example NH₃, in order to obtain a pH value lying in the range 4 to 5.5 and then dispersing the sol according to stage c). In this case, a time of only one hour is necessary to obtain the gelling of the dispersed droplets (stage d)). This is rendered necessary because at pH 2 the gelling time is too long to be compatible with the requirements of production on a large scale, while at pH values higher and lower than 2 the gelling time decreases. In the case where the hydrolysis is nonetheless performed at pH 2, it is necessary to increase the pH to decrease the gelling time. However, it was noticed that at acidic pH the gelling time is regulated by the molarity of the acid, thus the pH at which the hydrolysis will take place will also be that which will regulate the gelling time. For the purposes of the present invention, the tetraalkoxysilane used can be selected from tetramethyl orthosilicate (TMOS), tetraethyl orthosilicate (TEOS) and tetrapropyl orthosilicate (TPOS), the preferred tetraalkoxysilane being tetraethyl orthosilicate (TEOS).

Further, before, during or after the stage of addition of the sol the suspension of the sol can be stirred. In particular, the stirring speed, the geometry and the dimensions of the impeller and of the vessel/reactor, and the presence of baffles, can influence the geometry of the particles or beads obtained.

In one aspect of the invention, the solvent in which the sol obtained from stage a) is added in stage b) to a dispersant liquid in which it is immiscible, which is selected from apolar organic solvents, preferably having a dielectric constant lower than 60 at 20° C. For example, said dispersant liquid can be selected from alkanes such as hexane, heptane, octane or nonane, from alcohols such as heptanol, octanol, nonanol or decanol or from aromatic compounds such as benzene, toluene, nitrobenzene, chlorobenzene, dichlorobenzene, quinoline, decalin or mixtures of such solvents.

Alternatively, silicone oil, such as for example liquid polydimethylsiloxane such as Dimethicone (Wacker Chemie AG, Wacker AK 50), can be used as the dispersant liquid.

Preferably, the quantity of immiscible liquid which must be used is such that the immiscible solvent/sol or sol-gel ratio by weight lies between ca. 8:1 and 3:1, and preferably it is 3:1.

The rate of addition of the sol to the dispersant liquid with which it is immiscible and in which it is made to remain for a period of about one or two hours, in other words until complete gelling of the sol, though it is not critical, must be regulated depending on the particular equipment (volume to be added, volume of the vessel, shape and speed of the stirrer) in such a manner as to obtain the desired dimensions of the droplets, as will be illustrated below.

In one aspect of the invention, the system is also subjected to stirring in the course of the stage c) of dispersion of the particles or beads obtained in stage b). In particular, the stirring speed influences the size of the particles or beads, which will be smaller the greater the stirring speed. For example, to have spherules or beads of dimensions of ca. 10-15 mm, an anchor stirrer with 4 arms which rotates at low speed, preferably lying between 40 and 80 rpm, is advantageously used.

The geometry and the size of the vessel/reactor also influence the size of the particles obtained, which, with equal stirring speed and impeller size will be greater if the vessel is of larger size. Conversely, the presence of baffles, which cause the formation of vortices and turbulence, favours the formation of smaller particles, even of diameter less than 100 μm.

In one aspect of the invention, in stage e) the particles are poured from the reactor onto a suitable filter, preferably in the form of a net having meshes of known size, lying for example between 400 and 800 mesh and preferably of ca. 600 mesh (20 microns).

After the filtration, the spherules or beads are washed with a suitable solvent selected for example from dioxan, propanol, acetone, ethanol, ethyl acetate, butyl acetate or isoamyl acetate. The purpose of this stage is to remove both the dispersant, for example silicone oil, and the water used for the hydrolysis reaction, from the spherules of gel. The removal of the water is necessary because in the final stage of the process, removal of the washing solvent under critical conditions, the presence of water to an extent greater than 5% relative to the gel of silica causes breakage of the spherules themselves.

If the dispersion according to stage c) has been performed in silicone oil, the implementation of stage e) is suitable for obtaining products with different characteristics depending on how the latter is performed.

According to a first aspect of the invention, if the washing in stage e) is performed with ethanol or acetone, it has surprisingly been found that, even after repeated washings, the spherules obtained after drying (stage f)) have a high degree of hydrophobicity. This property only disappears after calcining of the dried spherules at temperatures lying between 250° C. and 450° C. in a current of air and the final material is found to be perfectly hydrophilic. A hydrophilic property for the spherules is of particular interest for applications in the field of thermal or sound insulation.

In another aspect of the invention, the stage e) can be performed with solvents which have high compatibility with the silicone oil used in phase c) such as for example butyl acetate or ethyl acetate, even if followed by washing with acetone, and in this case the spherules after drying (stage f)) are found to be perfectly hydrophilic without them having to be calcined.

The final stage of the process, stage f), relates to the removal of the solvent used for the washing. In the present invention, the removal is performed under critical conditions with regard to the solvent used. From this point of view it is obvious that a solvent with critical constants of pressure and temperature which are not too high is preferable. For this purpose, in the present invention it is possible to use a change of solvent after having performed the washing stage. For example the washing with ethanol or with ethyl acetate can be followed by a washing with acetone or pentane so as to replace completely the solvents used in the washing. The hypercritical drying will be performed under lower conditions of temperature and pressure compared to those of the solvents used for the washing since the critical constants of temperature and pressure of acetone and pentane (T_{c} 508° C., P_{c} 4.7 MPa for acetone and T_{c} 470° C., P_{c} 3.370 MPa for pentane respectively) are lower than those of ethanol and ethyl acetate (T_{c} 514° C., P_{c} 6.137 MPa for ethanol and T_{c} 523° C., P_{c} 3.870 MPa for ethyl acetate respectively).

According to another aspect of the invention, the stage f) can be performed in CO₂ under critical conditions by following the stage e) of washing for the removal of the silicone oil and the water with one of the aforesaid solvents with a final washing with liquid carbon dioxide which removes the major part of the solvent used for the washing. In this case, the hypercritical drying is performed at a pressure of 73 bars and a temperature of 31° C. (which correspond to the critical constants of carbon dioxide) and which represent operating conditions which are particularly mild and thus suitable for industrial application.

The process described above, in accordance with a second subject of the present invention, advantageously and unexpectedly makes it possible to obtain an aerogel in the form of particles or beads having a spherical shape and a monomodal (homogeneous) size distribution having the following advantageous characteristics:
total porosity lying between 2 and 8 cm³/g and
overall surface area lying between 300 and 1300 m²/g.

According to a third subject of the present invention, the spherules or beads obtained with the process described are used in the field of thermal and sound insulation.

### EXAMPLE 1

### a) Preparation of the Sol

A 5 l reactor A is equipped with a helical stirrer. On the spherical base of the reactor there is a drainage tap which enables the final solution to be dripped out. The reactor is filled with 2500 g of 3.9M hydrochloric acid. The reactor is externally cooled to 5° C. with an ice/water bath and 850 g of tetraethyl orthosilicate (Dynasilan® A) are added dropwise into the cold acidic solution over a period of 30 mins from a dropping funnel fitted in the upper part of the reactor. 15 mins after the end of the dropwise addition, the initial two-phase mixture of acidic solution plus TEOS becomes a clear single-phase colloidal solution (sol). 20 ml are withdrawn from the clear solution and are stored in a 50 ml vial (control) and constitute a reference sample.

### b) Formation of the Spherules

A round-bottomed 20 l reactor B is equipped with a four-arm anchor stirrer with 90° spacing and with a tap located on the spherical bottom of the vessel for discharge of material. The reactor is charged with 11 litres of silicone oil (Wacker® AK50) and the double anchor stirrer is turned at a speed of 210 rpm. The length of the arms of the stirrer anchor is such that these project a few cm outside the surface of the silicone oil. Through the tap present at the bottom of the reactor A, the sol is dripped into the silicone oil in the reactor B over a period of 30 mins. A two-phase mixture made up of the silicone oil in which are dispersed small droplets of sol is formed. In this mixture, it would not be possible to detect that gelling of the sol has occurred since the droplets are too small and hence reference must be made to the portion of sol stored in the vial where the gelling process is reliably detected. Two hours after the end of the dropwise addition to the silicone oil, the reference sample gels. The stirring of the reactor is continued for a further 2 hrs in order to ensure the complete gelling of the spherules of sol mixed with the silicone oil. With the gelling, the spherules of sol are transformed into spherules of aquagel which, while maintaining their dimensions unchanged, can no longer give rise to coalescence phenomena. At this point, the oil/spherule mixture is poured, through the tap located at the bottom of the reactor, into a filter consisting of a cylindrical collecting vessel the bottom of which is formed of a 600 mesh (20 micron) stainless steel gauze. The oil is separated while the particles are poured into a vessel where they are washed 4 times with 5 l of ethyl acetate to remove the silicone oil which is still impregnating the siliceous material. The spherules wet with ethyl acetate are then washed with 10 l of acetone with the double purpose of replacing the ethyl acetate completely with acetone and of removing almost all of the water which is still present in the spherules of aquagel in order to be able to pass on to the following stage of hypercritical solvent removal. For this purpose, the gelled spherules are placed in a suitable glass vessel and covered with acetone up to the upper surface of the solid mass. The vessel is placed in an autoclave where it undergoes hypercritical drying.

The final material consists of 225 g of spherules of aerogel which on porosimetric analysis exhibit a surface area of 1000 m² per gram, and a pore volume of 3.8 cm³/g with a mean pore diameter value lying between 40 and 100 nm. From a weight/volume calculation, the spherule material has an apparent specific gravity of ca. 0.1 g/cm³.

### EXAMPLE 2

Operating with exactly the same procedures described in Example 1, 3.35 kg of sol are prepared in the reactor A and are added dropwise to the reactor B filled with 11 l of silicone oil (Wacker® AK50). Since it is desired to obtain spherules of larger dimensions, the reactor B is stirred at an impeller speed of 140 rpm during the dropwise addition of the sol. After gelling of the control has occurred, the reactor B is kept stirred for a further 2 hours and then the operations of filtration, washing with ethyl acetate and finally with acetone are performed maintaining the same proportions by volume as in Example 1. 235 g of spherules of aerogel are obtained whose diameter varies between 0.4 and 0.8 cm and which on porosimetric analysis exhibit a surface area of 1180 m² per gram, and a pore volume of 4.2 cm³/g with a mean pore diameter value lying between 40 and 100 nm. From a weight/volume calculation, the spherule material has an apparent specific gravity of ca. 0.1 g/cm².

### EXAMPLE 3

Operating with exactly the same procedures described in Example 1, 3.35 kg of sol are prepared in the reactor A and are added dropwise to the reactor B filled with 11 l of silicone oil (Wacker® AK50). Since it is desired to obtain spherules of still larger dimensions compared to Example 2, the reactor B is stirred at a stirrer speed of 80 rpm during the dropwise addition of the sol. After gelling of the control has occurred, the reactor B is kept stirred for a further 2 hours and then the operations of filtration, washing with ethyl acetate and finally with acetone are performed maintaining the same proportions by volume as in Example 1. 230 g of spherules of aerogel are obtained whose diameter varies between 1.0 and 2.0 cm and which on porosimetric analysis exhibit a surface area of 1200 m² per gram, and a pore volume of 6.0 cm³/g with a mean pore diameter value lying between 40 and 100 nm. From a weight/volume calculation, the spherule material has an apparent specific gravity of ca. 0.08 g/cm³.

1. A process for the preparation of an aerogel, the process comprising:
(a) hydrolyzing a tetraalkoxysilane, to obtain a colloidal solution (sol) of silicon dioxide;
(b) adding the sol from the hydrolyzing (a) to a dispersant liquid, wherein the sol is immiscible in the dispersant liquid, to obtain a two-phase composition;
(c) dispersing the two-phase composition to obtain particles or beads;
(d) gelling the dispersed particles or beads from the dispersing (c);
(e) filtering and washing the particles or beads from the gelling (d) with a solvent; and
(f) extracting the solvent,
wherein the particles obtained in (c) have a diameter between 0.1 and 15 mm.

2. The process of claim 1, wherein the hydrolyzing (a) is in an acid medium by an addition of a mineral acid.

3. The process of claim 1, wherein the tetraalkoxysilane is at least one selected from the group consisting of tetramethyl orthosilicate (TMOS), tetraethyl orthosilicate (TEOS), and tetrapropyl orthosilicate (TPOS).

4. The process of claim 1, wherein the hydrolyzing (a) is achieved by an addition of at least one mineral acid selected from the group consisting of phosphoric acid, hydrochloric acid, sulphuric acid and nitric acid.

5. The process of claim 1, wherein the hydrolyzing (a) is achieved by adding the tetraalkoxysilane to an acidic aqueous solution having a pH <2.

6. The process of claim 1, wherein the hydrolyzing (a) is performed at pH 2 and is followed by an addition of a base in order to reach a pH in a range of 4 to 5.5.

7. The process of claim 1, wherein the dispersant liquid in (b) is an apolar organic liquid having a dielectric constant less than 60 at 20° C.

8. The process of claim 7, wherein the dispersant liquid is selected from the group consisting of an alkane, an alcohol, an aromatic compound, and mixtures thereof.

9. The process of claim 1, wherein the dispersant liquid in (b) is a silicone oil.

10. The process of claim 1, wherein, during (b), the quantity of the dispersant liquid in which the sol is immiscible is such that the immiscible solvent/sol or sol-gel ratio by weight is between 8:1 and 3:1.

11. The process of claim 1, wherein the solvent in (e) is at least one selected from the group consisting of dioxane, propanol, acetone, ethanol, ethyl acetate, butyl acetate, and isoamyl acetate.

12. The process of claim 1, wherein the solvent in stage (e) is at least one selected from the group consisting of ethanol and acetone, thereby obtaining hydrophobic particles or beads.

13. The process of claim 1, wherein the solvent in (e) is butyl acetate or ethyl acetate, thereby obtaining hydrophilic particles or beads.

14. The process of claim 1, wherein the extracting (F) is by hypercritical extraction in an autoclave.

15. The process of claim 1, further comprising, after (e) and before (f)
(e′) replacing the solvent of (e).

16. The process of claim 12, wherein the solvent of in (e′) is at least one selected from the group consisting of acetone and pentane.

17. Particles or beads obtained by the process of claim 1, wherein the particles or beads have a total porosity between 2 and 8 cm³/g, an overall surface area between 300 and 1300 m²/g, a diameter of pores between 25 and 150 nm and an apparent specific gravity between 0.05 and 0.200 g/cm³.

18. The process of claim 1, further comprising, after (f), (g) calcinating the particles or beads,
wherein the solvent in (e) is acetone.

19. The process of claim 1, wherein the tetraalkoxysilane is tetraethyl orthosilicate (TEOS).

20. The process of claim 7, wherein the dispersant liquid is selected from the group consisting of hexane, heptane, octane, nonane, heptanol, octanol, nonanol, decanol, benzene, toluene, nitrobenzene, chlorobenzene, dichlorobenzene, quinoline, decalin, and mixtures thereof.
